(19) United States
(12) Patent Application Publication
(10) Pub. No.: US 2025/0305778 A1
(43) Pub. Date: Oct. 2, 2025

(54) COOLING MODULE, IN PARTICULAR FOR A VEHICLE

(71) Applicant: VALEO SYSTEMES THERMIQUES, Le Mesnil-Saint-Denis (FR)

(72) Inventors: Moussa Nacer-Bey, Le Mesnil-Saint-Denis (FR); Kamel Azzouz, Le Mesnil-Saint-Denis (FR); Julien Tissot, Le Mesnil-Saint-Denis (FR); Sebastien Garnier, Le Mesnil-Saint-Denis (FR)

(73) Assignee: VALEO SYSTEMES THERMIQUES, Le Mesnil-Saint-Denis (FR)

(21) Appl. No.: 18/864,404

(22) PCT Filed: May 10, 2023
(86) PCT No.: PCT/EP2023/062348

§ 371 Date: Nov. 8, 2024

(30) Foreign Application Priority Data
May 10, 2022 (FR) 2204438

(51) Int. Cl. F28F 9/007; F28F 9/02

(52) U.S. Cl. CPC F28F 9/0075; F28F 2009/0295

(57) ABSTRACT

A cooling module including a support including at least one channel for the flow of a heat-transfer fluid. The support bears at least one component with a fluidic function such as a valve or a pump. The cooling module also includes a box for distribution of the heat-transfer fluid, and the box is able to accommodate at least one heat-exchange component which is distinct from the component with a fluidic function, and is designed for circulation of a coolant fluid. The box is designed such as to permit within its interior an exchange of heat between the heat-transfer fluid and the coolant fluid. The box is formed at least partly by the support.

The present invention concerns a cooling module, in particular for a vehicle. The vehicle may be a land vehicle, marine vehicle or air vehicle. The cooling module is designed in particular to be used in a cooling system, or more generally a heat-control system, comprising in particular a heat pump.

A major factor at present for vehicles is the reduction of the size of the different items of equipment.

The invention proposes achieving the objective of reducing the size of a heat-control system.

The invention thus proposes a cooling module, in particular for a vehicle, this module comprising a support comprising at least one channel for the flow of a heat-transfer fluid, this support bearing at least one component with a fluidic function such as a valve or a pump, this module also comprising a box for distribution of the heat-transfer fluid, and this box being able to accommodate at least one heat-exchange component which is distinct from the component with a fluidic function, and being designed for circulation of a coolant fluid, the box being designed such as to permit within its interior an exchange of heat between the heat-transfer fluid and the coolant fluid, this box being formed at least partly by the support.

The heat-exchange component is for example a cooler with coolant fluid, also known as a chiller.

“Fluidic function” means a function which participates in the functioning of the module, which is selected for example to act on the flow of the heat-transfer fluid, or to measure a parameter associated with the fluid or its flow in the channels.

The invention makes it possible to obtain numerous advantages.

Firstly, the support fulfils several functions, i.e. at least one structural function, since it bears components, and a functional function, which makes it possible to obtain a compact module with a number of parts which can be limited.

In particular, the invention makes it possible to obtain a group of a plurality of components of a heat-transfer fluid hydraulic circuit in an optimum manner, in particular with a support which incorporates the hydraulic circuit.

In particular, the invention makes it possible not to have to use additional piping/pipes in order to connect different components to one another fluidically. These fluidic connections are produced directly by channels of the support.

The assembly of the different components to one another can be simplified since it is not necessary to use piping/pipes.

The invention thus makes it possible to reduce costs, since it makes it possible to dispense with numerous pipes in order to connect the components. The invention also makes it possible to reduce the weight of cooling fluid used.

In addition, as will be seen hereinafter, it is possible to use the support as an element constituting a valve or a pump for example. This makes it possible to achieve great compactness of the module.

The invention thus makes it possible to reduce the space occupied by the components, which makes it possible to reduce the overall size of the cooling module. In the case of a heat pump for example, the invention makes it possible to reduce the size of the assembly of the components thereof, in particular of the different fluid circuits.

In general, the structural support can be compact.

According to one of the aspects of the invention, the support comprises a first plate and a second plate assembled to one another in order to define the channel, these plates being joined and forming together a circumference of the channel.

According to one of the aspects of the invention, the channel is formed by a first cavity of the first plate and/or a second cavity of the second plate.

According to one of the aspects of the invention, the cavities are joined, and form together the circumference of the channel.

According to one of the aspects of the invention, the cavities are joined along a joining plane.

According to one of the aspects of the invention, the joining plane is parallel to the main plane of the plates.

According to one of the aspects of the invention, each cavity is formed by a cylindrical wall of the associated plate.

According to one of the aspects of the invention, the plates each comprise one or a plurality of flat regions present between cylindrical walls which form the channel(s).

According to one of the aspects of the invention, the plates each have a flat joining face onto which the associated cavity opens out.

According to one of the aspects of the invention, the joining faces of the plates each have an identical periphery.

According to one of the aspects of the invention, the plates are each made of a part in a single piece.

According to one of the aspects of the invention, the plates are made of metal.

According to one of the aspects of the invention, the plates are made by casting.

As a variant, the plates can be produced by injection or by drawing, depending on the material used.

According to one of the aspects of the invention, the plates are assembled to one another by welding or by adhesion.

According to one of the aspects of the invention, the module comprises units for securing the plates to one another, in particular securing lugs with complementary forms which are engaged with one another, or flanges, screws, nuts or rivets, this list being non-limiting.

According to one of the aspects of the invention, the module comprises units for securing the support on an exterior structure, and/or securing units for securing of the components such as valves or pumps, on the support.

These securing units are securing lugs with complementary forms which are engaged with one another, or flanges, screws, nuts or rivets, this list being non-limiting.

According to one of the aspects of the invention, the plates are welded or glued, in particular along the channel/channels, in order to make this channel or these channels sealed against the heat-transfer fluid along their entire length.

As a variant or as a complement to the welding or adhesion, at least one of the plates comprises at least one groove which is designed to receive a seal along the channel in order to assure the sealing of this channel.

According to one of the aspects of the invention, the plates have a plurality of cavities in order to form a plurality of channels.

According to one of the aspects of the invention, at least one of the channels is straight along at least a portion of its length.

According to one of the aspects of the invention, at least one of the channels has at least one bend or one branch for the flow.

According to one of the aspects of the invention, the box comprises a lateral wall, with a periphery which in particular is globally rectangular, this wall being produced integrally with the support, in particular with the first plate, this plate forming a base of the box.

According to one of the aspects of the invention, this lateral wall is perpendicular to the first plate.

According to one of the aspects of the invention, the channel(s) formed by the assembly of the plates extend(s) in line with this lateral wall.

According to one of the aspects of the invention, the first plate comprises one or a plurality of forms, in particular one or more recesses, which are at the foot of the lateral wall, and are designed to accommodate at least partly a component with a fluidic function such as a valve.

According to one of the aspects of the invention, the lateral wall comprises a network of reinforcement ribs, this network of ribs comprising in particular ribs which intersect perpendicularly.

According to one of the aspects of the invention, the lateral wall comprises a free rim which is designed to receive a cover.

### Variant

In another embodiment of the invention, the support comprises a single plate which is designed to bear the component(s).

According to one of the aspects of the invention, the channel is formed at least partly by piping which is on the exterior of the single plate.

According to one of the aspects of the invention, the piping is at a non-zero distance from the plate, at least along part of its length.

According to one of the aspects of the invention, the piping is an element distinct from the plate, and is for example secured, for example by welding, on the plate.

According to one of the aspects of the invention, the lateral wall of the box is added on and secured on the support, in particular on the single plate.

According to one of the aspects of the invention, the single plate forms the base of the box.

According to one of the aspects of the invention, the lateral wall is connected to a cover, which in particular is produced integrally with the lateral wall.

According to one of the aspects of the invention, in one embodiment of the invention, the assembled plates, or the single plate in the other embodiment of the invention, bear(s) at least one pump and/or one valve in order to act on the flow of the heat-transfer fluid circulating in the distribution box.

According to one of the aspects of the invention, the distribution box is closed by a cover which is secured on the lateral wall.

According to one of the aspects of the invention, the cover is flat, and in particular comprises an opening for the passage of a connection flange forming an inlet and an outlet for coolant fluid of the heat-exchange component.

According to one of the aspects of the invention, in a known manner, the heat-exchange component for the coolant fluid comprises tubes in which the coolant fluid circulates.

According to one of the aspects of the invention, the support comprises a plurality of hydraulic circuits, for different types of fluids.

According to one of the aspects of the invention, the support, which for example is provided with two assembled plates or a single plate, bears at least one of the following components:
a pump to pump the heat-transfer fluid;
a valve for orientation of the heat-transfer fluid;
a non-return valve for the heat-transfer fluid;
a throttle valve for the heat-transfer fluid;
a plate exchanger, in particular an evaporation exchanger, which is also known as a chiller;
a condensation exchanger, in particular a “water condenser”;
an electrical heating resistor which is designed to heat the heat-transfer fluid;
a desiccant bottle for the circuit dedicated to the coolant fluid;
a filter to filter particles which are present in the heat-transfer fluid, in particular a dielectric fluid.

According to one of the aspects of the invention, the support, which for example is provided with two assembled plates or a single plate, forms part of a body of the valve or the pump.

Thus, the fluidic function is formed by a part of the structural body of the component.

According to one of the aspects of the invention, the valve is a throttle valve.

According to one of the aspects of the invention, the valve is a valve for orientation of the flow, in particular of the 3-way or 4-way type.

According to one of the aspects of the invention, the component advantageously incorporates component elements of the valve, for example one or a plurality of mobile flaps.

According to one of the aspects of the invention, the pump can be actuated by an electric motor.

According to one of the aspects of the invention, the support is provided with at least two receptacles in order to receive two pumps.

According to one of the aspects of the invention, one of the components bears a sensor in order to measure a characteristic of the fluid or of the flow of the fluid, the sensor for example being a temperature sensor in order to measure the temperature of the fluid.

According to one of the aspects of the invention, the component with a fluidic function comprises a functional element such as a valve or a flap or a piston, this functional element being incorporated in one of the channels formed by the support.

According to one of the aspects of the invention, the box comprises a free rim which is designed to receive a cover.

According to one of the aspects of the invention, the cover is substantially flat, in particular with an opening for the passage of a fluidic connection flange for the circulation of coolant fluid in the heat-exchange component which is accommodated in the box.

According to one of the aspects of the invention, the support comprises at least one fluidic connection joining piece, which is designed to connect the channel(s) of the support to fluid piping.

This fluidic connection joining piece can be of the male type, designed to cooperate with piping which is of the female type, or conversely.

According to one of the aspects of the invention, the heat-transfer fluid is selected from among: a dielectric fluid, a cooling fluid such as water or a mixture of water and ethylene glycol, or a coolant fluid such as R134a, R1234yf or R744.

The subject of the invention is also a heat-transfer fluid circuit of a heat pump, comprising a module as previously described.

Within the context of a heat pump, the invention makes it possible to compact the assembly of the components of the module, these components being able to belong to a coolant circuit and to a heat-transfer fluid circuit of the heat pump.

Other characteristics and advantages of the invention will become more apparent from reading the following description, provided by way of non-limiting illustration, and from the appended drawings, in which:

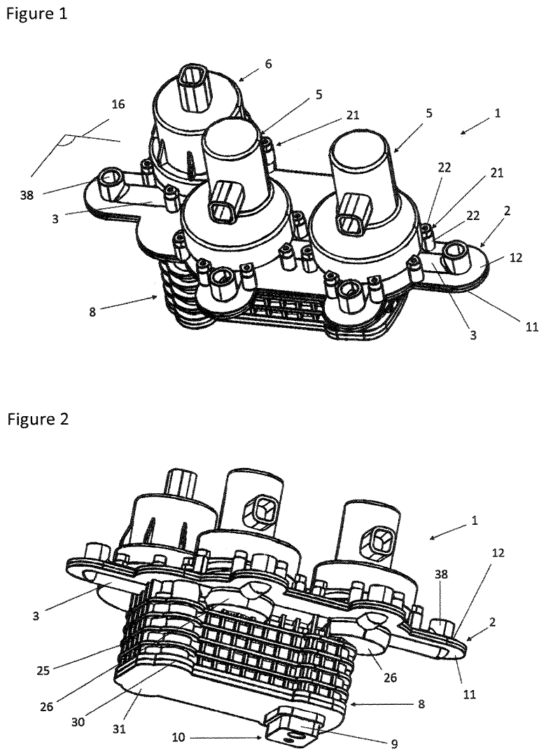

FIG. 1 illustrates schematically and partly, in perspective, a module according to an embodiment of the invention;

FIG. 2 illustrates schematically and partly, in perspective, the module of FIG. 1, according to a different view;

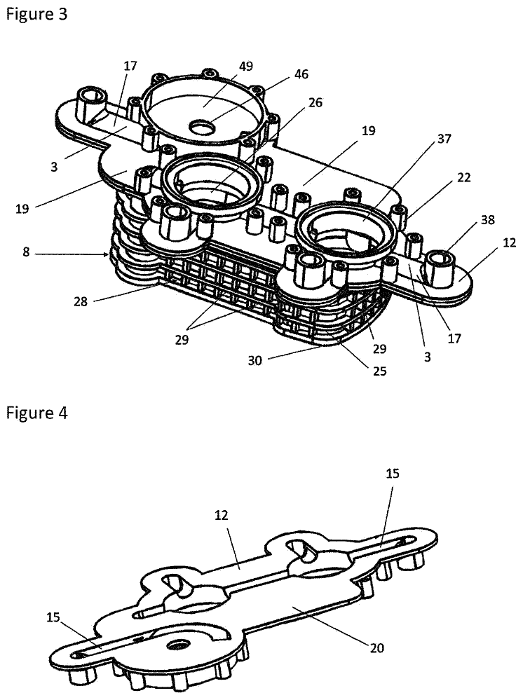

FIG. 3 illustrates schematically and partly, the module of the view of FIG. 1, without the components fitted on it;

FIG. 4 illustrates schematically and partly, one of the plates of the support of the module of FIG. 1;

FIG. 5 illustrates schematically and partly, the other one of the plates of the support of the module of FIG. 1;

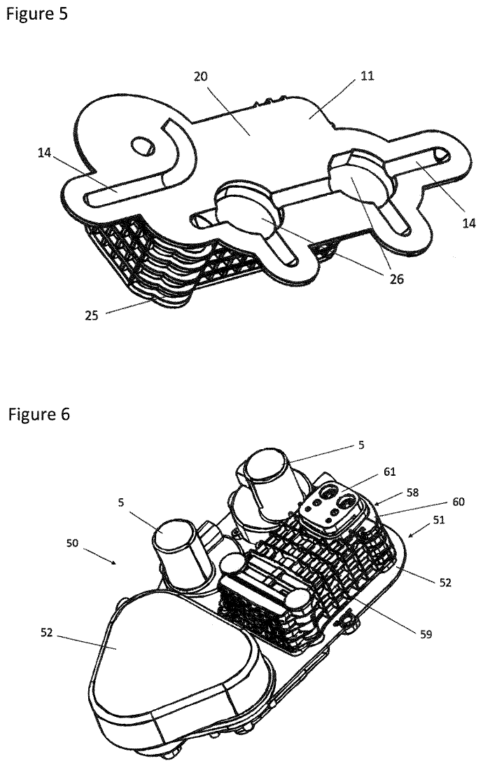

FIG. 6 illustrates schematically and partly, in perspective, a module according to another embodiment of the invention;

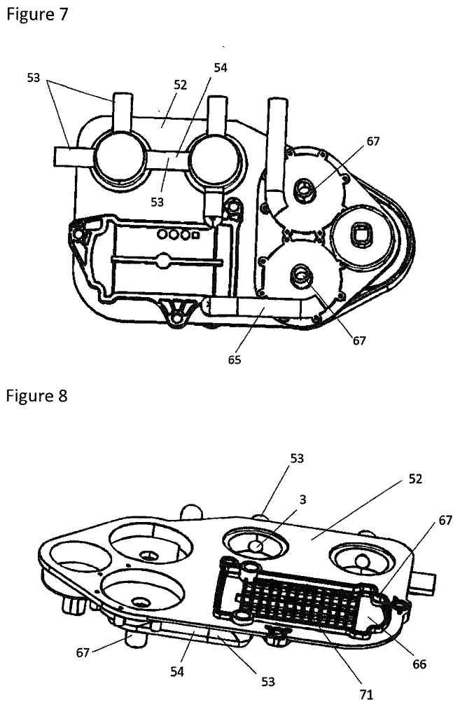

FIG. 7 illustrates schematically and partly, the module of FIG. 6, according to another view;

FIG. 8 illustrates schematically and partly, the support of the module of FIG. 6, in isolation.

FIGS. 1 and 2 represent a cooling module 1 according to an embodiment of the invention, which module is designed to be used in a heat pump system on board a vehicle.

This module 1 is incorporated in a heat-transfer fluid circuit, which can be a water circuit of the heat pump. This water circuit is associated with a coolant fluid circuit of the heat pump, in order to permit exchanges of heat between the heat-transfer fluid and the coolant fluid.

The heat pump will not be described in greater detail, since it is known from the prior art. The invention can be adapted to a large number of types of cooling circuits, since the different components can be selected to provide the different functions required.

The cooling module 1 comprises a support 2 comprising a plurality of channels 3 for the flow of a heat-transfer fluid, which for example contains mainly water.

This support 2 bears components with a fluidic function consisting of two valves 5 and a pump 6.

These valves 5 are for example multiple-way valves for the control of circulation of the heat-transfer fluid.

The pump 6 makes it possible to put this heat-transfer fluid into motion, and can be actuated by an electric motor.

This module 2 also comprises a box 8 for distribution of the heat-transfer fluid, and this box 8 can accommodate a heat-exchange component 10 distinct from the aforementioned components 5 and 6 with a fluidic function.

The heat-exchange component 10 is for example a cooler with coolant fluid, also known as a chiller. Only a flange 9 of this component 10 can be seen in FIG. 2.

The box 8 is designed such as to permit an exchange of heat in its interior between the heat-transfer fluid and the coolant fluid.

This box 8 is formed by the support 2.

This support 2 comprises a first plate 11 and a second plate 12 which are assembled with one another in order to define the channels 3, these plates 11 and 12 being joined and forming together a circumference of each channel 3.

Each channel 3 is formed by a first cavity 14 of the first plate 11, and a second cavity 15 of the second plate 12, as can be seen in particular in FIGS. 4 and 5.

As illustrated in FIGS. 1 and 3, these cavities 14 and 15, formed by a cylindrical wall 17 of the associated plate, are joined, and form together the circumference of each of the channels 3. These cavities 14 and 15 are thus half-channels of the channels 3.

These cavities 14 and 15 are joined along a joining plane 16 which is parallel to the main plane of the plates 11 and 12.

The plates 11 and 12 each comprise a plurality of flat regions 19 adjacent to the cylindrical walls 17 which form the channel(s) 3.

The plates 11 and 12 each have a flat joining face 20, which joining faces 20 have identical outer peripheries which coincide.

The plates 11 and 12 are each made of a part in a single piece, which for example is metal.

The plates 11 and 12 are produced by casting or by injection or by drawing, depending on the material used.

The plates 11 and 12 are assembled to one another by welding or by adhesion, via the joining faces 20.

The module 1 comprises securing units 21, in order to secure the valve 5 and pump 6 components on the support 2.

These securing units 21 comprise screws which engage in respective small columns or lugs 22 of the plate 12 and of the components 5 and 6.

The plates 11 and 12 are welded or glued along the channels 3, in order to seal these channels 3 against the heat-transfer fluid along their entire length.

According to one of the aspects of the invention, at least one of the channels is straight along at least a portion of its length.

Certain channels 3 have a straight direction.

The box 8 comprises a lateral wall 25, with a globally rectangular periphery, this wall 25 being produced integrally with the first plate 11 which forms a base of the box 8.

This lateral wall 25 is perpendicular to the first plate 11.

Certain channels 3 extend in line with this lateral wall 25.

The first plate 11 comprises a plurality of forms 26, in this case recesses, which are at the foot of the lateral wall 25, and are designed to accommodate one of the valves 5 partly.

The lateral wall 25 comprises a network of reinforcement ribs 28, comprising ribs 29 which intersect perpendicularly.

The lateral wall 25 comprises a free rim 30 which is designed to receive a cover 31.

The cover 31 is flat, and comprises an opening 33 for the passage of the connection flange 9, forming an inlet and an outlet for coolant fluid of the heat-exchange component 10.

In a known manner, this heat-exchange component 10 comprises tubes or plates in which the coolant fluid circulates.

The support 2, provided with two assembled plates 11 and 12, forms part 37 of a body of the valve 5 or the pump 6. This part 37 is an annular collar on the plate 12, the valve 5 or the pump 6 supported on the respective collar 37.

The support 2 comprises fluidic connection joining pieces 38 designed to connect the channels 3 of the support to fluid piping.

Each fluidic connection joining piece 38 can be of the male type, designed to cooperate with piping which is of the female type, or conversely.

These joining pieces are produced integrally with the plate 12.

The heat-transfer fluid circulates in the components 5 and 6 in the interior space of the box 8.

As illustrated in FIG. 3, the pump 6 is accommodated in a cavity 49 of the support 2, and an aspiration orifice 46 is provided in the support 2, in order to permit fluidic communication with the pump 6.

The coolant fluid which circulates in the cooler 10 is in particular of the R134a, R1234yf or R744 type.

In another embodiment of the invention, illustrated in FIGS. 6 to 8, the module 50 is provided with a support 51 which comprises a single plate 52 designed to bear the components including valves 5.

The channels 3 are each formed by piping 53 which is on the exterior of the single plate 52.

The piping 53 comprises straight portions 54 which are at a non-zero distance from the plate 52.

At least some of the piping 53 consists of parts distinct from the plate 52, which are secured, for example by welding, on the plate 52.

The plate 52 and the piping 53 can be produced separately, but from the same material, for example metal.

The lateral wall 59 of the distribution box 58, which carries out the same function as the box 8 described above, is secured on the single plate 52 which forms the base of the box 58. In other words, the box 58 is formed partly by the support 51.

This lateral wall 59 is produced integrally with a globally flat cover 60.

Thus, the lateral wall 59 and the cover 60 are formed by a part in a single piece, for example of plastic or of metal.

A flange 61 is provided on the cover 60 in order to put coolant fluid into fluidic communication with the heat-exchange component accommodated in the box 58.

Components with a fluidic function which are borne by the plate 52 are accommodated in the interior of a cap 62 secured on this plate 52.

In this example, heat-transfer fluid can circulate between a pump 6 and the distribution box 58 by means of piping 65, as illustrated in FIG. 7.

The plate 52 comprises a region 66 which is provided with ribs 71, and is designed to receive the component with coolant fluid, which region is bordered by a divider 69 which cooperates with the lateral wall 59.

Each pump 6 is associated with piping 67 which is perpendicular to the plate 52, as represented in FIG. 7.

As a reminder, “fluidic function” means a function which participates in the operation of the module, and for example is selected to act on the flow of the heat-transfer fluid, or to measure a parameter associated with the fluid or with its flow in the channels.

1. A cooling module comprising:
a support comprising at least one channel for the flow of a heat-transfer fluid,
wherein the support bearing at least one component with a fluidic function,
wherein the one component with a fluidic function comprises a valve or a pump;
a box for distribution of the heat-transfer fluid,
wherein the box is configured to accommodate at least one heat-exchange component distinct from the component with a fluidic function, and is designed for circulation of a coolant fluid,
wherein the box is designed to permit within its interior an exchange of heat between the heat-transfer fluid and the coolant fluid,
wherein the box is formed at least partly by the support.

2. The cooling module as claimed in claim 1,
wherein the support comprises a first plate and a second plate assembled to one another in order to define the channel,
wherein the plates are joined and forming together a circumference of the channel.

3. The cooling module as claimed in claim 2, wherein the channel is formed by a first cavity of the first plate and/or a second cavity of the second plate.

4. The cooling module as claimed in claim 1, wherein the support comprises a single plate designed to bear the component(s).

5. The cooling module as claimed in claim 1,
wherein the box comprises a lateral wall, with a periphery,
wherein the periphery is globally rectangular,
wherein the lateral wall comprising a network of reinforcement ribs,
wherein the network of ribs comprising ribs which intersect perpendicularly.

6. The cooling module as claimed in claim 5,
wherein the lateral wall is produced integrally with the support, in particular with a first plate of the support,
wherein the this first plate forming a base of the box.

7. The cooling module as claimed in claim 6, wherein the lateral wall comprises a free rim designed to receive a cover.

8. The cooling module as claimed in claim 5, wherein the lateral wall of the box is added on and secured on the support

9. The cooling module as claimed in claim 1, wherein the support is provided with two assembled plates or a single plate, bears at least one of the following components:
a pump to pump the heat-transfer fluid;
a valve for orientation of the heat-transfer fluid;
a non-return valve for the heat-transfer fluid;
a throttle valve for the heat-transfer fluid;
a plate exchanger;
a condensation exchanger;
an electrical heating resistor which is designed to heat the heat-transfer fluid;
a desiccant bottle for the circuit dedicated to the coolant fluid; and
a filter to filter particles which are present in the heat-transfer fluid.

10. A heat-transfer fluid circuit of a heat pump, comprising the cooling module as claimed in claim 1.
